(19) United States
(12) Patent Application Publication
(10) Pub. No.: US 2026/0157284 A1
(43) Pub. Date: Jun. 11, 2026

(54) AUTONOMOUS TRACTOR AND METHOD TO CULTIVATE FARMLAND USING THIS TRACTOR

(71) Applicant: Agxeed Holding B.V, Oirlo (NL)

(72) Inventors: Joris Jan HIDDEMA, Grubbenvorst (NL); Laurentius Hubertus Margaretha Schmitz, Mariahoop (NL)

(21) Appl. No.: 18/706,674

(22) PCT Filed: Nov. 1, 2022
(86) PCT No.: PCT/EP2022/080419

§ 371 Date: May 1, 2024

(30) Foreign Application Priority Data
Nov. 2, 2021 (NL) 2029583

(51) Int. Cl. A01D 75/20; A01B 69/04; F16P 3/14

(52) U.S. Cl. CPC A01D 75/20; A01B 69/008; F16P 3/14

(57) ABSTRACT

An autonomous tractor for autonomously cultivating a piece of farmland according to a predetermined cultivation plan, the tractor when cultivating the farmland operates using a standard safety mode defining a first set of conditions under which the tractor leaves the predetermined cultivation plan and switches to a safety plan, and when a human operator is present near the tractor when cultivating the piece of farmland, the tractor has the option of operating using a second safety mode, defining a second set of conditions under which the tractor leaves the predetermined cultivation plan and switches to the safety plan, wherein the second set of conditions is less stringent than the first set of conditions.

### GENERAL FIELD OF THE INVENTION

The present invention pertains in general to autonomous tractors for autonomously crossing and cultivating farmland.

### BACKGROUND ART

The adoption of technology in agriculture has improved the approaches that farmers use in the farmland nowadays. Modern agriculture has made it easy for farmers to achieve high produce while using less input. According the trends in the use of technology in agriculture, there are high concerns that the future of agriculture is bright. For example, mechanization in agriculture has reduced the overuse of manpower in doing some of the farming activities. As a consequence, agricultural machines have become bigger and bigger and more dedicated towards performing one type of cultivation. The introduction of autonomous tractors is considered a next step into the future of farming and it is expected that using autonomous tractors, the trend of bigger and more dedicated (specialised) farming machines will continue.

Self-driving cars are common these days. Based on the trends in regards to the advancement of technology, it is expected that the technology will also be used for cultivating farmland. At present farmers in advanced countries are giving a tactical approach to how they plant, harvest, as well as maintain their crops. A good example of new tactical approaches is the use of autonomous tractors in agriculture. The concept of autonomous tractors can be traced back prior to the introduction of the concept of precision farming in the eighties. During these days, farmers used GPS technology as a guide to the tractors across the farmland. The aim of such an approach was the reduction of fuel consumption and enhancing the efficiency of the tractors and the farming activities. As such, these initial steps formed the basis for the development of autonomous tractors, following the introduction of technologies that improved communication over wireless devices. Autonomous tractors employ much the same approach as the driverless vehicles, i.e. using advanced control systems and sensors. With the inclusion of auto-steering abilities, such tractors have added control abilities. Evidently, the launch of the autonomous tractors is considerably a manifestation of the extended use of technology in farming.

Benefits to farmers are obvious. It is an undeniable fact that farming is not an easy undertaking, it involves working for long hours and the subscription to hard labor in harsh weather conditions. Taking into consideration the common state of farmers, the majority of them have no employees to task them in the farmland and hence, have to do everything all by themselves. The autonomous tractors can be a positive outcome. Next to this, accuracy and precision are important aspects in agriculture in various aspects such as planting. Regarding for example such planting, the autonomous tractors can be equipped with automatic planting systems that ensure high accuracy when planting. With such abilities, farmers are assured of seed conservation. All in all, the use of such tractors may lead to higher return on investment since accuracy is enhanced.

One of the factors that hinder agricultural production in both developed and developing countries is the lack of enough labor. Normally, farmers grow a small section of land which they are sure to manage with their limited labor. However, with the adoption of the autonomous tractors, the problem of labor insufficiency is catered for since the number of employees needed to cultivate the farmland may be reduced.

It is generally recognized that data plays a significant role in determining the farmers'decisions. Usually, the absence of clear and reliable data can interfere with the decisions farmers make, and subsequently, have adverse impacts on the amount of outcome obtained from the fields. There are diverse sources and types of data that a farmer needs to succeed in their farming activities. For example, data on soil is important in that it helps farmers in determining what crops will do well in a given piece of land by establishing the moisture content, and the amount of nutrients. The autonomous tractors can be fitted with various sensors that can be used in the collection of data on the conditions of the soil, and hence, offer a platform for improving the outcome of the available crops. The elimination of the human interaction in farming following the use of autonomous tractors may thus be advantageous. Stressed employees cannot achieve the required efficiency level in the fields. Similarly, it is often hard for humans to manage diverse tasks on the farm especially where a large farmland is involved. Autonomous tractors have the appropriate sensors to offer the necessary help in the management of a several tasks in the farmland hence reducing stress and the workload in the farm.

The autonomous tractors run on high level technology that can be used in gathering high profile information. For example, some models have automatic steering abilities and GPS technologies which enhance the control of the tractors'course. The advanced sensors come in handy in the determination of soil moisture level, activities around planting and harvesting, present yield, as well as the amount of fuel needed for a given area of land. Additionally, other models of autonomous tractors can guide farmers on how to apply fertilizers.

Autonomous tractors allow precise control of work and farm equipment. This makes it possible for farmers to extend their working hours. The sensors fitted in the tractors can guide it in the right course even in conditions of reduced visibility and at night: work continues even during windy, dusty, and foggy conditions. Additionally, the ability of the tractors to reduce workload and stress on employees comes in handy in increased working hours in a day since the farmer has a greater flexibility in the management of growing tasks.

It has thus become a common understanding that the best way for using an autonomous tractor is to establish a cultivation plan to cultivate the piece of land, which plan for examples defines the routing and speed of the tractor over the land, as well as the way the actual agricultural machine (which may be part of the tractor or coupled thereto) is operated (for example its driving speed, its height with respect to the land, its angle with respect to the land etc.), and using the sensor technology to adapt this predetermined plan to the particular circumstances of the moment in time the land is actually cultivated. Such circumstances can for example be objects that were not present at the piece of land at the time the plan was made, the weather conditions, etc. Thus, with appropriate sensor technology, it is commonly believed that one is able to completely pre-plan the cultivation operation. However, In the art it is recognised that sometimes intervention of the autonomous cultivation by a human operator is desired, examples of which are described here below.

U.S. Pat. No. 7,502,678 (assigned to Claas Selbstfahrende Erntemaschinen GmbH) pertains to a method for precise planning the cultivation of a piece of land, in which method a route is created for the autonomous tractor, which includes working tracks along which the tractor is driven while the piece of farmland is being cultivated, and which includes headland tracks, along which the tractor is driven when it travels from one working track to the next working track. The used system automatically processes a sequence of headland working steps at the end of one working track and/or while a subsequent headland track is being driven along, and/or at the beginning of a subsequent working track. The sequence of headland working steps is updated and carried out dynamically depending on the current position of the tractor and depending on the next working track to be driven along. An automatic control system for controlling the tractor is provided. Still, the method allows an operator to switch from the predetermined plan, to one of a set of alternative routes, if desired by the operator.

Likewise in U.S. Pat. No. 10,394,238 (assigned to CNH Industrial America Ltd), a method for operating an autonomous tractor is disclosed, in which method alternative routes are generated for certain parts of the farmland. The method includes generating a number of plans for the autonomous tractor, determining a plan value for each of the number of plans, selecting a mission plan with the highest plan value, and executing the selected mission plan to control the autonomous tractor while leaving the option open for operator intervention to switch to one of the alternative plans, for example when the operator determines that the automatically selected plan is suboptimal.

U.S. Pat. No. 10,795,351 (assigned to Raven Industries Inc.) discloses a system and method of controlling an autonomous tractor which combines geographical coordinates, machine settings, machine position, path plans, user input, and equipment parameters to generate executable commands based of a variety of different in-field agricultural operation objectives for a vehicle equipped with an automatic or electronically controlled locomotion systems capable of reading and executing the commands. The system allows a human operator to make changes to the operation settings while the tractor is underway. For example, when an agricultural operation is to control a grain cart the operator may wish to increase or decrease speed of the tractor relative to a combine. By providing an interface which allows the operator to adjust such settings on the go the system serves as a remote control.

US patent application 2019/0364,734 (assigned to Claas Selbstfahrende Erntemaschinen GmbH) discloses a method and apparatus for controlling an agricultural harvesting campaign, in which predetermined harvesting activities are processed within a campaign timeline by a plurality of agricultural working machines of a machine fleet on a field allotment assigned to the harvesting campaign. The control of the harvesting campaign is executed on different application levels by continuously generating information, wherein the generated information is continuously provided to all of the application levels, and the generated data comprise remotely-sensed field information. In the method, use is made of so called field zones to be transmitted in the machine control routine to the respective machine control of at least one, some or all of the autonomous tractors. In the method, although in principle automated, the field zones may and displayed. The operator of the respective tractor may accordingly check whether or not the division of the field zones corresponds to the actual conditions with regard to operating quality. On this basis, the user may intervene to correct the control of the tractor.

DE 20 2006 042 547 A1 (assigned to Bartec GmbH) discloses a tractor that is operator driven, which tractor raises an alarm if people wearing a tag come to close to the tractor. The driver may decide to slow the vehicle down or even stop it. Operators can be distinguished from non-operators by having a particular code, and may be allowed closed to the tractor before the alarm is raised. The technology is not suitable for use with autonomous tractors that work in various remote locations since a driver needs to be present for recognising people or other by-passers that are not tagged.

### OBJECT OF THE INVENTION

It is an object of the invention to devise an autonomous tractor that leads to improved cultivation, while at the same time meeting sufficient safety requirements.

### SUMMARY OF THE INVENTION

In order to meet the object of the invention, an autonomous tractor for autonomously crossing farmland was devised, the tractor when cultivating the farmland operates (typically under automatic control of a central processing unit, a “CPU”) using a standard safety mode defining a first set of conditions under which the tractor leaves the predetermined cultivation plan and switches to a safety plan (i.e. a plan with less likelihood of an accident happening), wherein when a human operator is present near the tractor when cultivating the piece of farmland, the tractor has the option of operating using a second safety mode, defining a second set of conditions under which the tractor leaves the predetermined cultivation plan and switches to the safety plan, wherein the second set of conditions is less stringent than the first set of conditions.

The invention is based on several recognitions. The prime one is the following: although a predetermined cultivation plan, combined with adequate sensor technology typically allows for an effective cultivation of the land, the inventors did realise that in many cases, fine-tuning of the actual plan is still necessary to reach improved (or advantageously optimal) cultivation. The same way, a farmer driving a regular tractor also fine tunes the cultivation process when cultivating the land, even without being aware of this. When the farmer starts working the land, and he is close to the action (driving his tractor) he actually senses the action and automatically fines tunes variables such as speed, working depth etc. to particular circumstances. Indeed, to be able and fine tune the actual cultivation operation, the inventors realised it is necessary that the operator needs to be (very) close to the tractor. However, safety regulations typically prevent that a human person can come as close to the tractor as needed for fine-tuning, without switching to a safety mode to prevent an accident. For adequate fine tuning it is crucial of course that the tractor remains operating according to the regular cultivation plan and not for example to switch to a lower speed or worse, even stop.

The inventors were able to devise a tractor that takes safety into account, and still allow fine-tuning by an operator. For this, it is important that the tractor is provided with a standard safety mode to comply with legally or ethically required safety standards, and to try and prevent accidents with people while the tractor is working on the land. However, it is advantageous to have the option available for operation under a second safety mode with applies less stringent (that it, less strict) conditions, allowing operations that would normally lead to a switch to the safety mode. For example, a trained operator of the tractor could be allowed to be present closer to the tractor than an untrained random passer-by under its normal operation, since the trained operator is well aware of the potential danger of the tractor and in particular where to stay away from. This on its turn, when the option of operation under the second safety mode is exercised, means than an operator could come as close as needed to the tractor while cultivating the land under standard conditions, to be able and fine-tune the operation even if he is at a position which in the standard safety mode would lead to an immediate switch to the safety plan (for example slowing down the machine or even stopping it). The fine-tuning can lead to any adaptation of the original cultivation plan, which after implementation leads to improved cultivation, while at the same time still allowing safe operation. As soon as the operator is satisfied with the acquired level of quality, he can move away from the tractor and lift the second safety mode, returning to the standard safety mode. All-in-all, the present invention allows an operator to undertake actions, in particular fine-tuning of the cultivation operation, that in the standard mode would lead to leaving the cultivation plan and switching to the safety plan.

It was found that this way, the quality of cultivation can be improved, while not undoing regular safety standards. The technical features of the autonomous tractor as worded here above and in the appended claims can be implemented by a skilled technician using common knowledge. For example, it is known that autonomous tractors cultivate using predetermined cultivation plans. This is inherently necessary since there is no operator to drive the vehicle over the farmland. Also, the use of safety modes is commonly known in the art of autonomous vehicles. Many of such vehicles have sensors to detect objects that might interfere with the movement of the vehicle according to the plan, and if such an object is detected, the vehicle stops cultivating according to the predetermined plan and switches to a safety mode, typically stopping the vehicle, or raising an alarm, slowing down etc, depended om what was established as an unforeseen object or other issue. Also, establishing the presence of an operator is common knowledge, typically using a transponder, RID tag, personal cell phone etc.

The invention is also embodied in a method to cultivate a piece of farmland with an autonomous tractor according to a cultivation plan, the tractor when cultivating the farmland operates using a standard safety mode defining a first set of conditions under which the tractor leaves the cultivation plan and switches to a safety plan, and when a human operator is present near the tractor when cultivating the piece of farmland, the tractor has the option of operating using a second safety mode, defining a second set of conditions under which the tractor leaves the predetermined cultivation plan and switches to the safety plan, wherein the second set of conditions is less stringent than the first set of conditions, wherein the method comprises establishing the cultivation plan to cultivate the piece of land; positioning the tractor on the piece of land; starting the cultivation according to the established cultivation plan; a human operator going near the tractor; exercising the option to use the second safety mode, allowing the human operator to act while meeting the first set of conditions, without the tractor switching to the safety plan as long as the operator does not meet the second set of conditions; the human operator assessing a quality of the cultivation according to the cultivation plan and optionally adapting this cultivation plan (when needed) to improve the quality; the human operator moving away from the tractor; the tractor leaving the second safety mode; and the tractor cultivating the piece of land according to the cultivation plan, optionally as adapted by the human operator.

### DEFINITIONS

A tractor is an agricultural vehicle that is used cultivate land, typically by pulling or carrying agricultural machinery, and to provide the energy needed for the machinery to cultivate the land (including any harvesting action). It commonly, but not necessarily, is a powerful vehicle with a gasoline or electric engine and large rear wheels or endless belt tracks (so called caterpillar tracks).

An autonomous tractor is a tractor that can move over a piece of land according to a predetermined cultivation plan without a human operator controlling its movement. Such a tractor can automatically perceive its environment, make decisions based on what it perceives and recognizes, and then actuate a movement or manipulation within that environment. These decision-based actions may include, but are not limited to, starting, stopping, and maneuvering around obstacles that are in its way. Such a tractor can cross farmland without needing continuous control of a human operator, and thus is able to autonomously cultivate the land.

Farmland is land that is used for or suitable for farming.

An operator of a machine or device is a human person that is trained to control this machine or device.

A cultivation plan for a tractor to cultivate a piece of land, is a plan which defines at least the position, direction and speed of the tractor when crossing the land such that the land in essence can be cultivated completely.

A safety mode is a mode wherein safety measures are taken to prevent an accident from happening. Such measures can be for example to use an alarm, to lower the speed of the tractor, to alter its direction of movement or even to stop the tractor.

A condition being less stringent than another condition for switching to a safety measure, means that this condition is less strict or tight, thus allowing more freedom to operate before the safety measure is actually taken. For example, the condition for stopping an autonomous tractor when a person comes near the machine is less stringent when the condition is “when a person comes within 5 meters form the tractor” when compared to the condition “when a person comes within 30 meters form the tractor”.

To identify a person is to recognise who that person is or of what kind, for example by establishing that the person is one of the persons that are present on a particular list of persons (to establishing who the person is), or that the person meets predetermined criteria (thus establishing what the person is, for example “an operator having permission X”).

Operator initiated means that something, for example a machine or a chain of events, is started by an operator positively acting, for example by pushing a button, switching device to a certain mode etc.

Automatic means without the need of (human) operator intervention. The term automatic does not exclude that something is operator initiated or operator stopped as long the process can be completed without needing operator intervention.

### EMBODIMENTS OF THE INVENTION

In a first further embodiment of the tractor according to the invention, the first set of conditions pertain to one or more standard zones around the tractor, and the second set of conditions pertains to one or more high risk zones around the tractor, which high risk zones are less extended with respect to the tractor than the standard zones. It is foreseen that in the standard safety mode the tractor has multiple zones around the tractor that each lead to corresponding actions in the safety plan. For example, in the widest zone around the tractor, a person entering the zone could lead to an alarm bell and flashlight to warn the person to stay away. In a second more restricted zone, entering of a person could lead to the tractor slowing down significantly to try and minimize collision. Entering a third even more restricted zone could lead to the tractor immediately stopping to prevent collision of the person with a running tractor. The same way, there could be multiple high risk zones around the tractor with corresponding (or other) safety measures when an operator would enter. However, these high risk zones are less extended with respect to the tractor to allow an operator to come closer to the tractor than a random passer-by without switching to the safety mode. For example, it could be that the widest high risk zone correspond to the third standard zone, and that any further high risk zones are even less extended. In any case, the widest high risk zone is less extended with resect to the tractor than the widest standard zone. It is noted that the extension of the zones, thus, the distance over which they extend from the tractor does not need to be fixed. They may very well depend on the local speed of the tractor, the type of cultivation operation, the position of the tractor on the piece of land, the time of the day, the weather circumstances etc.

In yet a further embodiment of the tractor according to the invention the first set of conditions is such that when an unidentified person enters the said one or more standard zones, the tractor switches to the safety plan. Although other conditions can be applied in order to maintain safe operation, it was found simple and effective to apply as a condition the mere presence of an unidentified person (which does not exclude that the person actually is an operator, however not yet identified) as such in one of the standard zones. Preferably and likewise, the second set of conditions is such that when the operator enters the one or more high risk zones, the tractor switches to the safety plan.

In another embodiment of the autonomous tractor according to the invention, the second safety mode is used with respect to the operator only. This means that the less stringent condition only apply to the operator and not to any other (unidentified, random) person. This prevents that the safety of the device with respect to non-operator persons is less when the tractor is operated using the second safety mode.

In again another embodiment, exercising the option of using the second safety mode is operator initiated. This means that only the operator that is near the tractor can switch the tractor to the second mode. This is to increase the level of safety and prevent that the second mode can be chosen from a remote location from which it may be difficult to establish whether it is safe to switch to that mode. Preferably, operator initiation is followed by a step of identification of the operator when present near the tractor, and only when the operator is identified, the option of using the second safety mode is exercised. This further increase the level of safety. In this embodiment, only predetermined operators, for example the ones that have gotten special training about this particular tractor or type of farmland, are able to switch the tractor to the second safety mode. Further preferably, the identification of the operator as such is an automatic process, such as for example using biometrics or any other operator specific characteristics (such as for example a batch with RFID chip).

In still another embodiment, the tractor when cultivating the farmland is able to operate using the standard safety mode and the second safety mode at the same time. This way, even when the second safety mode is active, the standard safety mode can be used with respect to non-operators (random by-passers), or more particular, with respect to non-identified operators.

In yet again another embodiment, after the option of using the second safety mode is exercised, this second safety mode is automatically left after a predetermined amount of time. This is also to increase safety and prevent that the tractor maintains its less stringent safety conditions for the operator even during the time it is not needed for this operator to come close to the tractor for fine-tuning or any other action.

It is noted that any and all embodiments as described here above or exemplified here after in the examples section for the tractor according to the invention can also be embodied in the method according to the invention.

The invention will now be further illustrated using the following specific examples.

### EXAMPLES OF THE INVENTION

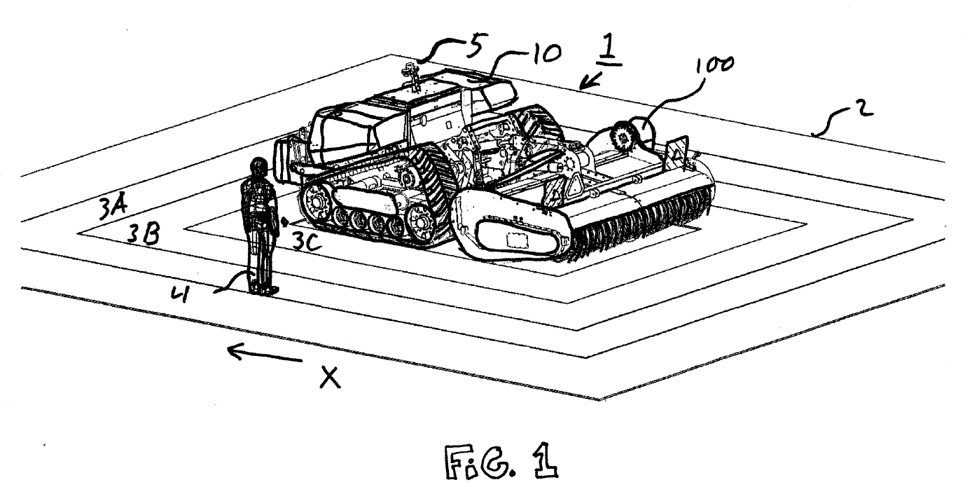

FIG. 1 schematically shows an autonomous tractor and its standard safety zones.

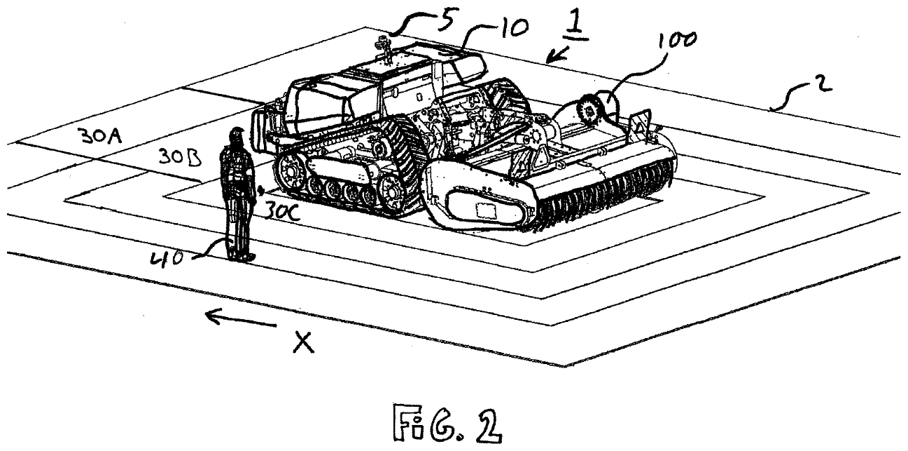

FIG. 2 schematically shows an autonomous tractor and its high risk zones.

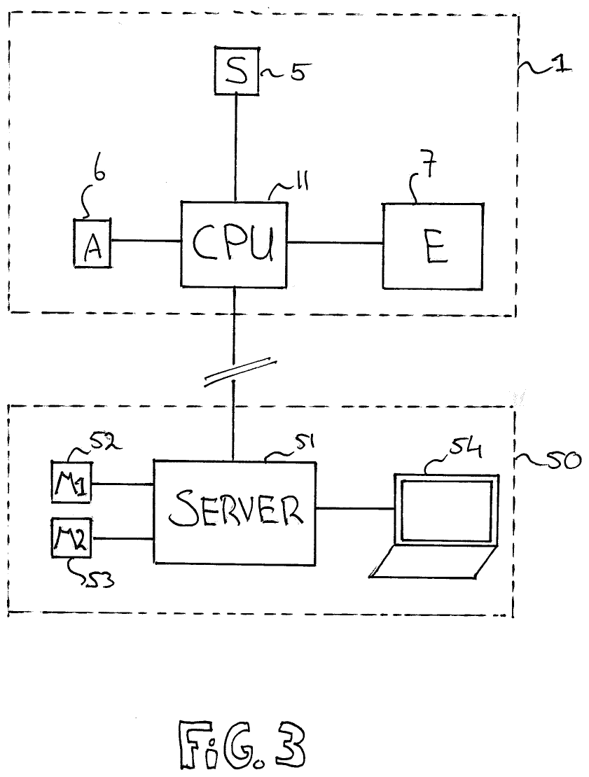

FIG. 3 schematically shows a control diagram for the tractor of FIGS. 1 and 2.

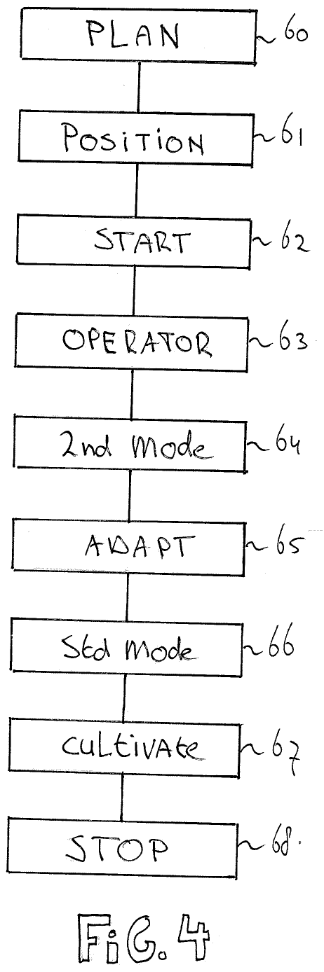

FIG. 4 is a flow diagram describing a method according to the invention.

### FIG. 1

FIG. 1 schematically shows an autonomous tractor 1 and its standard safety zones 3a, 3b and 3c. The tractor in fact is a combination of a pulling vehicle 10, which is an autonomous vehicle (such as known for example from WO2020/106143, assigned to Agxeed BV). The vehicle 10 pulls an agricultural machine 100 for performing a cultivation operation on the piece of land 2. For this, the tractor moves in the direction as indicated (see “X” in FIG. 2), which movement is part of a predetermined cultivation plan to cultivate the entire piece of farmland 2 (not shown in its entirety).

For safety reasons, the tractor 1 operates using a standard safety mode. In this mode a set of three standard zones is created around the tractor, indicated as 3a, 3b and 3c respectively in FIG. 1. These zones travel in conjunction with the tractor and may vary in length and width depending on the position of the tractor on the farmland 2, its speed and the weather conditions. The presence of a person in one of these zones is continuously monitored using sensor 5. In FIG. 1, a random passer-by 4 is present in zone 3a. Because of this, the tractor leaves the predetermined cultivation plan and switches to the safety plan. In this plan, as long as the person 4 does not enter any of the zones 3b or 3c, the speed and cultivation operation is maintained according to the predetermined plan, but the tractor raises an alarm and a continuously repeated warning message directed to the person (“Danger, Go Away”). Would the person enter zone 3b instead of moving away from the tractor, the tractor will continue to use the alarm and warning message, as well as slow down to 50% of the speed when compared to the predetermined plan. This makes it easier for the tractor to make an emergency stop when needed. Such a stop would be needed if the person 4 enters zone 3c.

When the person 4 moves away from the tractor, and ultimately leaves the standard zones 3, the tractor will eventually resume cultivation of the piece of farmland according to the predetermined cultivation plan. It is foreseen, in particular after the tractor has made an emergency stop, that resuming standard operation by leaving the safety plan needs operator initiation. This could for example be done from a remote location, but could also be done by an operator present at the piece of farmland, near the tractor 1.

### FIG. 2

FIG. 2 schematically shows an autonomous tractor 1 and its high risk zones 30a, 30b and 30c. In FIG. 2, the same reference numbers are used for the same features as depicted in FIG. 1. The main difference with FIG. 1 is that now an identified operator 40 is present near the machine in order to fine-tune the operation of the tractor 1. The operator in this case is automatically identified using biometrics, which identification process is automatically started after the operator has indicated on a mobile communication device that he is near the tractor and desires to be identified such that the option for the tractor to operate under a less stringent safety regime can be exercised. As long as the operator 40 is not yet positively identified, the tractor operates using the standard safety mode and corresponding standard zones as indicated with respect to FIG. 1. However, as soon as the operator 40 is identified, the option is exercised and the tractor switches to operation (still according to the predetermined cultivation plan) using a second safety mode which has less stringent safety conditions, leaving more freedom for the operator 40 to operate close to the tractor, for example for assessing the quality of the operation and fine-tuning the predetermined cultivation plan. These less stringent conditions come about by defining three high risk zones, that are considerably less extended with respect to the tractor 1 than the standard zones (compare 30a, 30b and 30c with 3a, 3b and 3c of FIG. 1). When the operator enters high risk zone 30a, the tractor will switch to the safety plan and slow down about 40% (in this embodiment, the safety plan arrived at starting from the second safety mode uses other safety measures than the safety plan arrived at from the standard safety mode). When the operator enters zone 30B, the tractor will slow down another 40%, such that the tractor operates at about 20% of its speed according to the predetermined cultivation plan. Would the operator enter zone 30C, the tractor will stop immediately performing an emergency stop. After such a stop, before the tractor can resume operation according to the predetermined cultivation plan, the same operator has to indicate, for example by using a remote control, that such operation may be resumed. For the other zones, simply leaving the zones means that operation according to the predetermined cultivation plan will be resumed automatically, thus not needing operator initiation. However, the tractor will in that case still operate using the second safety mode. This mode can be left, thus switching to the standard safety mode, for example by the operator indicating this on his remote control, or automatically when the operator has moved away sufficiently from the tractor, or automatically after a predetermined amount of time has lapsed since exercising the option (such as for example 30 minutes).

In an embodiment, the tractor operates using both safety modes at the same time when an operator is present near the tractor. The standard safety mode is used with respect to any person except the operator, and the second mode is used only with respect to the identified operator only.

### FIG. 3

FIG. 3 schematically shows a control diagram for the tractor 1 of FIGS. 1 and 2. The tractor 1 has a central processing unit 11, that is connected (wired or wireless; this is the same for any other connection in FIG. 3) to sensor 5, alarm 6 and engine 7. The CPU controls the engine when cultivating a piece of farmland according to a predetermined cultivation plan that was made at a remote location 50, using computer 54 and dedicated software. The computer is connected to a server 51 that on its turn is connected to CPU 11. The tractor operates normally using the standard safety mode defining a first set of conditions under which the tractor leaves the predetermined cultivation plan and switches to a safety plan. This is all under the control of CPU 11 (which might also be present at a remote location, thus not being part of the actual tractor, or distributed over the tractor and one or more remote locations). The conditions are established at location 50 as well and stored in memory 52. In this memory, different sets of conditions are stored that correspond to the standard safety mode. Depending for example on the type of tractor, the type of cultivation, the type of farmland (size, proximity to urban areas, etc), the weather conditions, a particular set of conditions can be chosen to be used for the operation using the standard safety mode. Likewise, the memory 52 holds multiple distinct sets of conditions for the second safety mode. The second memory 53 holds a list of operators that when identified when near the tractor 1 using sensor 5, may lead to exercising the option of operating the tractor using the second safety mode having less stringent safety conditions.

### FIG. 4

FIG. 4 is a flow diagram describing a method according to the invention. In step 60, a cultivation plan is established to cultivate a piece of land. In the next step (61), a tractor for performing the plan is positioned on the piece of land. The tractor is started in step 62 and operates according to the cultivation plan, using a standard safety mode (which would not allow the operator to come very near to the tractor without triggering the safety plan). Then, for the purpose of potentially fine-tuning the operation in order to increase the quality of the cultivation, in step 63 an operator comes near the tractor, and initiates exercising the option of operation using a second safety mode, indicated in step 64, having less stringent safety conditions. This allows the operator to act without the tractor switching to the safety plan as long as the operator does not meet the set of conditions that correspond to the second safety mode. This enables the operator to assess the quality of the cultivation according to the cultivation plan and if needed, to adapt this cultivation plan, for example to improve the quality of the cultivation. If the plan is indeed adapted in step 65, the adapted plan replaces the original predetermined cultivation plan. The operator might stay a while to assess cultivation according to the new plan and if satisfied, he moves away from the tractor. This triggers the tractor to leave the second safety mode and turn back to the standard safety mode in step 66. Thereafter, the tractor cultivates the piece of land in step 67 according to the cultivation plan as adapted by the human operator until the whole piece of land is cultivated according to plan. Ultimately, the tractor is stopped in step 68, and can be picked up to bring to another piece of farmland.

What is claimed is:

1. A method for controlling an autonomous tractor for autonomously cultivating a piece of farmland according to a predetermined cultivation plan, the method comprising the steps of:
controlling the tractor when cultivating the farmland to operate using a standard safety mode defining a first set of conditions under which the tractor leaves the predetermined cultivation plan and switches to a safety plan, and
when a human operator is present near the tractor when cultivating the piece of farmland, providing the tractor with the option of operating using a second safety mode, defining a second set of conditions under which the tractor leaves the predetermined cultivation plan and switches to the safety plan, wherein the second set of conditions is less stringent than the first set of conditions.

2. A method according to claim 1, further comprising the step of defining the first set of conditions to pertain to one or more standard zones around the tractor, and the second set of conditions to pertain to one or more high risk zones around the tractor, which high risk zones are less extended with respect to the tractor than the standard zones.

3. A method according to claim 2, wherein the first set of conditions is such that when an unidentified person enters the said one or more standard zones, the tractor switches to the safety plan.

4. A method according to claim 2, wherein the second set of conditions is such that when the operator enters the one or more high risk zones, the tractor switches to the safety plan.

5. A method according to claim 1, wherein the second safety mode is used with respect to the operator only.

6. A method according to claim 1, further comprising the step of exercising the option of using the second safety mode which is initiated by the operator.

7. A method according to claim 6, further comprising the step, following operator initiation, of identification of the operator when present near the tractor, and only when the operator is identified, the option of using the second safety mode is exercised.

8. A method according to claim 7, wherein the identification of the operator is an automatic process.

9. A method according to claim 1, further comprising the step of providing that the tractor when cultivating the farmland is adapted to operate using the standard safety mode and the second safety mode at the same time.

10. A method according to claim 1, further comprising the step of, after the option of using the second safety mode is exercised, automatically leaving this second safety mode after a predetermined amount of time.

11. A method to cultivate a piece of farmland with an autonomous tractor according to a cultivation plan, the tractor when cultivating the farmland operates using a standard safety mode defining a first set of conditions under which the tractor leaves the cultivation plan and switches to a safety plan, and when a human operator is present near the tractor when cultivating the piece of farmland, the tractor has the option of operating using a second safety mode, defining a second set of conditions under which the tractor leaves the cultivation plan and switches to the safety plan, wherein the second set of conditions is less stringent than the first set of conditions, wherein the method comprises:
establishing the cultivation plan to cultivate the piece of land;
positioning the tractor on the piece of land;
starting the cultivation according to the established cultivation plan;
exercising the option to use the second safety mode, when a human operator nears the tractor, allowing the human operator to act while meeting the first set of conditions, without the tractor switching to the safety plan as long as the operator does not meet the second set of conditions;
allowing the human operator to assess a quality of the cultivation according to the cultivation plan and optionally adapting this cultivation plan to improve the quality;
the tractor leaving the second safety mode when the human operator moves away from the tractor; and
providing for the tractor cultivating the piece of land according to the cultivation plan, optionally as adapted by the human operator.
